(19) United States
(12) Patent Application Publication
(10) Pub. No.: US 2006/0242668 A1
(43) Pub. Date: Oct. 26, 2006

(54) Method for displaying personal information in an interactive television programme

(76) Inventor: Jerome Chouraqui, Paris (FR)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/562,515

(22) PCT Filed: Jul. 2, 2004
(86) PCT No.: PCT/FR04/01726

§ 371 Date: Mar. 7, 2006

(30) Foreign Application Priority Data
Jul. 2, 2003 (FR) 03/08051

(51) Int. Cl. H04N 7/173; H04N 5/445; H04N 7/10; H04N 7/025; G06F 13/00; H04N 7/18; G06F 3/00

(52) U.S. Cl. 725/46; 725/100; 725/34; 725/35; 725/74

(57) ABSTRACT

A process for displaying personal information in an interactive television broadcast comprising: acquiring personal information with the aid of personal equipment, transmitting the personal information to a server for broadcasting content, transmitting the personal information from the server for broadcasting content comprising formatting data comprising the personal information intended to be used by application software of the interactive television and encapsulating the data in a format for the transportation of a video stream, wherein the encapsulated data is broadcast as a multiplex with video streams corresponding to a televised broadcast associated with the personal information and the user simultaneously displays and removes video information and the personal information.

### RELATED APPLICATION

This is a §371 of International Application No. PCT/FR2004/001726, with an international filing date of Jul. 2, 2004 (WO 2005/006751 A2, published Jan. 20, 2005), which is based on French Patent Application No. 03/08051, filed Jul. 2, 2003.

### FILED OF THE INVENTION

This invention relates to the area of interactive television. The invention relates more particularly to a process for displaying personal information in a broadcast of interactive television. The process applies to personal information in the form of short SMS messages.

### BACKGROUND

EP 1,188,314 discloses a process and system of communication for displaying short messages on TV screens. Short messages are sent by mobile terminals of a mobile phone system to a TV broadcasting unit identified by a corresponding telephone number. The short messages are converted into TV broadcasting signals in the unit and introduced into the television network in such a manner that they can be displayed on the TV sets linked to the television network.

It would therefore be advantageous to provide a process that permits on the one hand use of an interactive television decoder and on the other hand superposing of personal information and a television broadcast.

### SUMMARY OF THE INVENTION

This invention relates to a process for displaying personal information in an interactive television broadcast including acquiring personal information with the aid of personal equipment, transmitting the personal information to a server for broadcasting content, processing the personal information from the server for broadcasting content including formatting data including the personal information intended to be used by application software of the interactive television and encapsulating the data in a format for the transportation of a video stream, wherein the encapsulated data is broadcast as a multiplex with video streams corresponding to a televised broadcast associated with the personal information and the user simultaneously displays and removes video information and the personal information.

This invention also relates to a system that displays the personal information according to the process including means for acquiring the personal information, a transmitter and a display.

### BRIEF DESCRIPTION OF THE DRAWINGS

The invention will be better understood with the aid of the following description, given solely by way of explanation, of an embodiment of the invention making reference to the attached figure.

FIG. 1 shows the process in accordance with aspects of the invention.

### DETAILED DESCRIPTION

This invention concerns in a general sense a process for displaying personal information in an interactive television broadcast comprising:
a stage for the acquisition of the personal information with the aid of personal equipment,
a stage for the transmission of the personal information to a server for the broadcasting of content,
a stage for processing information coming from the server for broadcasting content including putting it in a format intended to be used by the application software of the interactive television and in encapsulating the data in a format for the transportation of video stream,

characterized in that the encapsulated data is broadcast in multiplexing with the video streams corresponding to the televised broadcast associated with the personal information, and in that it also comprises a stage that can be actuated by the user for simultaneous displaying and removal of video information and the personal information.

The transport format of the personal information is preferably the MPEG format. The personal information may be short SMS messages. The personal information may also be multi-media MMS messages. The personal information may further be digital images.

The personal information may be acquired on a portable phone and transmitted to the server of a telecommunication operator. Also, the personal information may be acquired on a personal computer.

The information processing stage advantageously comprises an operation for aggregation of the personal information including constructing at least one queue constituted of a plurality of messages.

The information processing stage may comprise an operation for aggregation of the personal information including constructing a plurality of queues.

Furthermore, the process advantageously comprises a stage for filtering personal information encapsulated as a function of parameters recorded on the user equipment. The personal information advantageously contains a header comprising personalizing data of the filtering stage of the equipment of a TV viewer or of a group of TV viewers.

The process also comprises a stage for displaying information of an advertising nature. The information of an advertising nature may be of the text type. The information of an advertising nature preferably comes from graphic files. The graphic files may be in the JPEG, GIF, PNG or BMP format.

The process may comprise a stage for construction of multiple streams from bits of personal information, each comprising a part of the personal information, before the information processing stage.

The different streams preferably allow broadcasting into different chat rooms.

The invention also relates to a system for implementing the process comprising at least means for acquisition of the personal information, transmission means and display means.

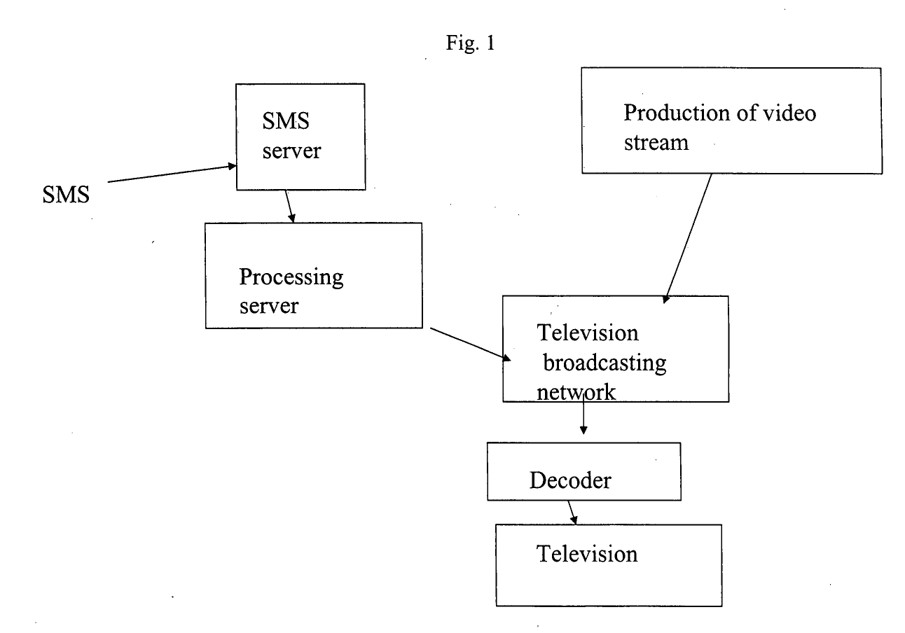

In the embodiment shown in FIG. 1, the personal information is in the form of SMS and the content broadcasting server is an SMS server.

A television broadcast is produced in the form of video stream and transmitted to the television broadcasting network.

The short message (SMS) issued from the personal equipment is transmitted to the SMS server, e.g., via a mobile telephony network, then to a server called the “processing server”.

The processing server receives the messages, authorizes their consultation or their suppression before transfer and stores them in a queue for a parameterable period.

The processing server places the short messages in a format for being exploited by the interactive television application software and encapsulates the data in a format for transporting a video stream.

The following stage includes associating within the television broadcasting network the digital data in the form of a video stream corresponding to the short messages with the digital data in the form of digital stream corresponding to the television broadcast. These two data types are then multiplexed and transmitted via the television broadcasting network to a decoder installed with a private party.

The decoder performs a demultiplexing operation on the video streams received and during the actuation that can be actuated by a TV viewer it commands the TV screen to display the content of the message and the television broadcast simultaneously.

The processing server may implement a stage for aggregation of several messages.

The invention was described above by way of example. It is understood that one skilled in the art is capable of realizing different aspects of the invention without departing from the scope of the appended claims.

1-18. (canceled)

19. A process for displaying personal information in an interactive television broadcast comprising:
acquiring personal information with the aid of personal equipment,
transmitting the personal information to a server for broadcasting content,
processing the personal information from the server for broadcasting content comprising formatting data comprising the personal information intended to be used by application software of the interactive television and encapsulating the data in a format for the transportation of a video stream, wherein the encapsulated data is broadcast as a multiplex with video streams corresponding to a televised broadcast associated with the personal information and the user simultaneously displays and removes video information and the personal information.

20. The display process according to claim 19, wherein the transport format of the personal information is an MPEG format.

21. The display process according to claim 19, wherein the personal information is short SMS messages.

22. The display process according to claim 19, wherein the personal information is multimedia MMS messages.

23. The display process according to claim 19, wherein the personal information is digital images.

24. The display process according to claim 19, wherein the personal information is acquired on a portable telephone and transmitted to a server of a telecommunication operator.

25. The display process according to claim 19, wherein the personal information is acquired on a personal computer.

26. The display process according to claim 21, wherein the information processing stage comprises an operation for aggregation of the personal information including constructing at least one queue constituted of a plurality of messages.

27. The display process according to claim 21, wherein processing the personal information comprises an operation for aggregation of the personal information including constructing a plurality of queues.

28. The display process according to claim 19, further comprising filtering personal information encapsulated as a function of parameters recorded on the personal equipment.

29. The display process according to claim 19, wherein the personal information contains a header comprising personalizing filtered data of equipment of a TV viewer or of a group of TV viewers.

30. The display process according to claim 19, further comprising displaying advertising information.

31. The display process according to claim 30, wherein the advertising information is text.

32. The display process according to claim 30, wherein the advertising information comes from graphic files.

33. The display process according to claim 32, wherein the graphic files are in JPEG, GIF, PNG or BMP format.

34. The display process according to claim 19, further comprising constructing multiple streams from bits of personal information, each comprising a part of the personal information, before processing the information.

35. The display process according to claim 34, wherein different streams allow broadcasting into different chat rooms.

36. A system that displays the personal information according to the process of claim 19, comprising means for acquiring the personal information, a transmitter and a display.
